(19) United States
(12) Patent Application Publication
(10) Pub. No.: US 2010/0180050 A1
(43) Pub. Date: Jul. 15, 2010

(54) COMMUNICATION SYSTEM CAPATIBLE TO UNIVERSAL SERIAL BUS (USB) AND METHOD THEREOF

(76) Inventors: Chung-liang Hsiao, Taichung City (TW); Jin-min Lin, Taipei City (TW)

Correspondence Address: AUSTIN RAPP & HARDMAN, 170 South Main Street, Suite 735, SALT LAKE CITY, UT, 84101, US

(21) Appl. No.: 12/430,266

(22) Filed: Apr. 27, 2009

(30) Foreign Application Priority Data
Jan. 13, 2009 (TW) 098101095

(51) Int. Cl. G06F 3/00

(52) U.S. Cl. 710/5; 710/8

(57) ABSTRACT

A communication system compatible to universal serial bus (USB) and method thereof are described. The communication system includes a client electronic device and a remote electronic device. The client electronic device establishes a communication link to the peripheral device connected to the remote electronic device. The client electronic device has a virtual host controller unit and a client application program module. The virtual host controller unit receives the control command and stores the control command. The client application program module sends the control command. The remote electronic device has a remote application program module and a physical host controller unit. The remote application program module analyzes the control command from the client application program module. The physical host controller unit performs the analyzed control command. The peripheral device based on the universal serial bus (USB) generates response data corresponding to the analyzed control command and the peripheral device based on the universal serial bus (USB) transmits the response data back to the device driver of the client electronic device.

### CLAIM OF PRIORITY

This application claims priority to Taiwanese Patent No. 098101095 filed on Jan. 13, 2009.

### FIELD OF THE INVENTION

The present invention relates to a communication system and method thereof, and more particularly relates to a communication system compatible to universal serial bus (USB) and method thereof.

### BACKGROUND OF THE INVENTION

FIG. 1 is a schematic block diagram of a conventional communication system 100. The communication system 100 includes a client computer 102 and a remote electronic device 104. The remote electronic device 104 is connected to the peripheral device 106 compatible to universal serial bus (USB) protocol. The client computer 102 has a first driver program 108 and a signal converter which is compatible to ultra-wide band (UWB) 110. The remote electronic device 104 has a signal converter which is compatible to universal serial bus (USB) protocol 112 and a second driver program 114. The signal converter which is compatible to ultra-wide band (UWB) 110 converts the signal complied with universal serial bus (USB) protocol to the signal complied with ultra-wide band (UWB). The signal converter which is compatible to universal serial bus (USB) protocol 112 converts the signal complied with ultra-wide band (UWB) to the signal complied with universal serial bus (USB) protocol. The communication system 100 employs the wireless technique including signal converter which is compatible to ultra-wide band (UWB) 110 and the signal converter which is compatible to universal serial bus (USB) protocol 112. The signal converter which is compatible to ultra-wide band (UWB) 110 converts the physical layer signal of universal serial bus (USB) protocol, thereby increasing the cost of the communication system 100. Since the protocol of ultra-wide band (UWB) is complicated, the certification and promotion of the communication system 100 using the ultra-wide band (UWB) is hard to be implemented. Moreover, the remote electronic device 104 need to conversely convert the signal complied with ultra-wide band (UWB) back to the signal complied with universal serial bus (USB) protocol by implementing the complicated protocol of ultra-wide band (UWB). Consequently, there is a need to improve the conventional communication system 100 employing the ultra-wide band (UWB) protocol.

### SUMMARY OF THE INVENTION

One objective of the present invention is to provide a communication system compatible to universal serial bus (USB) and method thereof so that at least one client computer is capable of controlling and accessing the peripheral device which is compatible to universal serial bus (USB) and connected to a remote electronic device as if the peripheral device compatible to universal serial bus (USB) is directly connected to the client electronic device. Thus, the client electronic device can directly control and access the peripheral device.

According to the above objective, the present invention sets forth a communication system compatible to universal serial bus (USB) and method thereof. The communication system includes a client electronic device and a remote electronic device. The client electronic device is coupled to at least one peripheral device based on the universal serial bus (USB) via the remote electronic device. The client electronic device is coupled to the remote electronic device via a communication interface.

The client electronic device establishes a communication link between the peripheral device and the communication system. The client electronic device includes a device driver, a virtual host controller unit, and a client application program module. The device driver is coupled to the virtual host controller unit. The client application program module couples the virtual host controller unit to the remote electronic device.

The device driver transmits a control command. In one embodiment, the control command is a reading command, a writing command and/or a device control command for controlling the peripheral device based on the universal serial bus (USB). The virtual host controller unit receives the control command from the device driver and stores the control command. The client application program module receives the control command from the virtual host controller unit and sends the control command.

The remote electronic device establishes a communication link between the peripheral device and the remote electronic device. The remote electronic device includes a remote application program module, a driving program module, and a physical host controller unit. The remote application program module couples the client application program module of the client electronic device to the driving program module. The driving program module is coupled to the physical host controller unit. The physical host controller unit is coupled to the peripheral device based on the universal serial bus (USB). When the remote electronic device establishes a communication link with the peripheral device, the remote electronic device enumerates the peripheral device.

The remote application program module analyzes the control command from the client application program module. The driving program module controls the peripheral device based on the universal serial bus (USB). The physical host controller unit performs the analyzed control command. The peripheral device based on the universal serial bus (USB) generates response data corresponding to the analyzed control command and the peripheral device based on the universal serial bus (USB) transmits the response data back to the device driver of the client electronic device.

The communication method of the present invention includes the steps of:

(a) A communication link between the peripheral device and the remote electronic device based on the universal serial bus (USB) is established. In one embodiment, the remote electronic device further enumerates the peripheral device based on the universal serial bus (USB).

(b) A communication link between the peripheral device and the client electronic device is established via the remote electronic device. In one embodiment, the client electronic device further enumerates the peripheral device based on the universal serial bus (USB).

(c) The device driver of the client electronic device transmits a control command to the virtual host controller unit.

(d) The remote application program module receives the control command from the virtual host controller unit and transmits the control command to the driving program module of the remote electronic device.

(e) The remote application program module analyzes the control command.

(f) The physical host controller unit performs the analyzed control command to allow the peripheral device based on the universal serial bus (USB) to generate response data corresponding to the analyzed control command.

(g) The peripheral device transmits the response data back to the device driver of the client electronic device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of a conventional communication system;

FIG. 2 is a schematic block diagram of a communication system compatible to universal serial bus (USB) according to one embodiment of the present invention; and

FIGS. 3A-3C are flow charts of performing the communicating method compatible to universal serial bus (USB) according to one embodiment of the present invention.

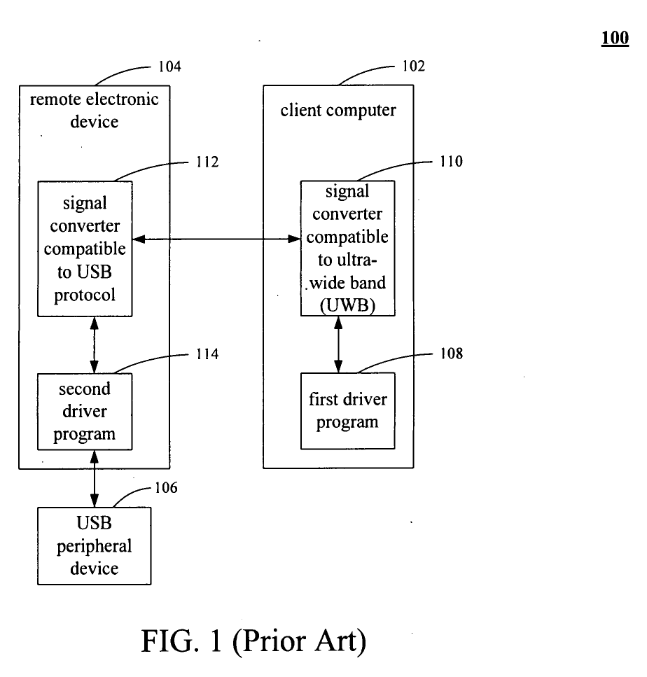

### DETAILED DESCRIPTION OF THE PREFERRED EMBODIMENTS

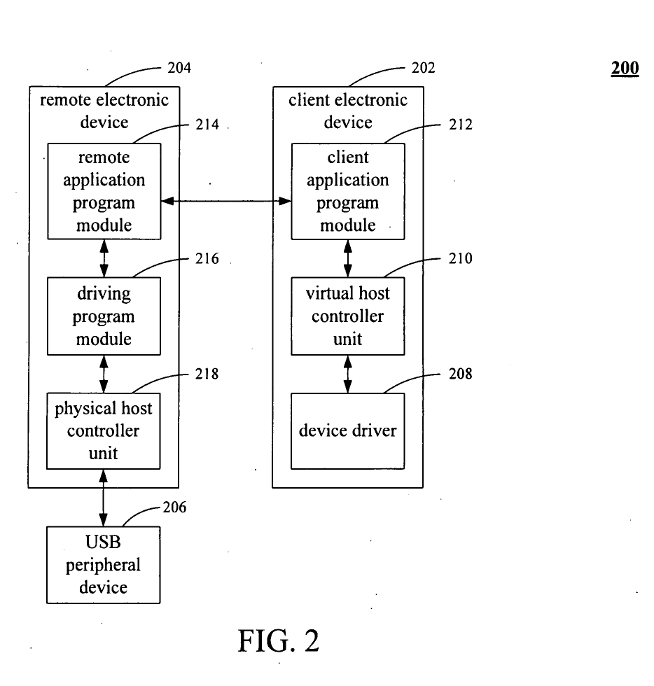

FIG. 2 is a schematic block diagram of a communication system 200 compatible to universal serial bus (USB) according to one embodiment of the present invention. The communication system 200 includes a client electronic device 202 and a remote electronic device 204. The client electronic device 202 is coupled to at least one peripheral device 206 based on the universal serial bus (USB) via the remote electronic device 204. The client electronic device 202 is coupled to the remote electronic device 204 via a communication interface, e.g. cable or wireless techniques. These techniques is compatible to a transmission control protocol/internet protocol (TCP/IP) in wide area network (WAN), local area network (LAN), Intranet, and/or IEEE 1394 (firewire). In one embodiment, the client electronic device 202 is a computer system and the remote electronic device 204 is a computer system or a base station, e.g. wireless access point. The communication system 200 remotely accesses (e.g. read/write) the peripheral device 206 based on the universal serial bus (USB) via the communication interface. That is, the remote ports compatible to universal serial bus (USB) in the remote electronic device 204 are regarded as the local ports compatible to universal serial bus (USB) in the client electronic device 202 so that the peripheral device 206 based on the universal serial bus (USB) can be controlled or shared by the client electronic device 202.

The client electronic device 202 establishes a communication link between the peripheral device 206 and the communication system 200. The client electronic device 202 includes a device driver 208, a virtual host controller unit 210, and a client application program module 212. The device driver 208 is coupled to the virtual host controller unit 210. The client application program module 212 couples the virtual host controller unit 210 to the remote electronic device 204.

The device driver 208 transmits a control command. In one embodiment, the control command is a reading command, a writing command and/or a device control command for controlling the peripheral device 206 based on the universal serial bus (USB). The virtual host controller unit 210 receives the control command from the device driver 208 and stores the control command. The client application program module 212 receives the control command from the virtual host controller unit 210 and sends the control command.

The remote electronic device 204 establishes a communication link between the peripheral device 206 and the remote electronic device 204. The remote electronic device 204 includes a remote application program module 214, a driving program module 216, and a physical host controller unit 218. The remote application program module 214 couples the client application program module 212 of the client electronic device 202 to the driving program module 216. The driving program module 216 is coupled to the physical host controller unit 218. The physical host controller unit 218 is coupled to the peripheral device 206 based on the universal serial bus (USB). When the remote electronic device 204 establishes a communication link with the peripheral device 206, the remote electronic device 204 enumerates the peripheral device 206.

The remote application program module 214 analyzes the control command from the client application program module 212. The driving program module 216 controls the peripheral device 206 based on the universal serial bus (USB). The physical host controller unit 218 performs the analyzed control command. The peripheral device 206 based on the universal serial bus (USB) generates response data corresponding to the analyzed control command and the peripheral device 206 based on the universal serial bus (USB) transmits the response data back to the device driver 208 of the client electronic device 202.

Specifically, while the remote electronic device 204 further enumerates the peripheral device 206 based on the universal serial bus (USB), the physical host controller unit 218 further establishes a physical device object (PDO) parameter of the peripheral device 206 by a descriptor parameter of the peripheral device 206 based on the universal serial bus (USB). The driving program module 216 establishes a functional device object (FDO) parameter based on the descriptor parameter. The driving program module 216 transmits a plurality of commands to the physical host controller unit 218 to allow the remote electronic device 204 further to enumerate the peripheral device 206 based on the universal serial bus (USB). In one embodiment, the driving program module 216 further includes an application program interface (API) to allow the remote application program module 214 to control the peripheral device 206 via the application program interface by using the analyzed control command. The remote application program module 214 further acquires the descriptor parameter of the peripheral device 206 based on the universal serial bus (USB).

While the client electronic device 202 enumerates the peripheral device 206 based on the universal serial bus (USB) via the remote electronic device 204, the virtual host controller unit 210 further establishes the physical device object (PDO) parameter of the peripheral device 206 based on the acquired descriptor parameter. The client electronic device 202 activates the device driver 208 according to the descriptor parameter. For example, a device driver program is added to the client electronic device 202.

The device driver 208 further transmits an enumeration command to the virtual host controller unit 210. The client application program module 212 further receives the enumeration command from the virtual host controller unit 210, and transmits the enumeration command to the physical host controller unit 218 of the remote electronic device 204 via the remote application program module 212 and the driving program module 214 sequentially. The peripheral device 206 based on the universal serial bus (USB) generates an enumerated response data corresponding to the enumeration command based on the enumeration command from the physical host controller unit 218. The peripheral device 206 based on the universal serial bus (USB) sends the enumerated response data back to the device driver 208 of the client electronic device 202 via the remote electronic device 204.

According to the above-mentioned descriptions, after the communication system 200 allows the remote electronic device 204 establishes a communication link to the peripheral device 206, the client electronic device 202 enumerates the peripheral device 206 based on the universal serial bus (USB) via the remote electronic device 204. The device driver 208 of the client electronic device 202 sends a control command to the virtual host controller unit 210 as if the remote electronic device 204 directly transmits the control command to the physical host controller unit 218 via the driving program module 216. The device driver 208 provides a control command to the virtual host controller unit 210 as though the remote electronic device 204 directly transmits the control command to the physical host controller unit 218 so that the client electronic device 202 can directly control and access the peripheral device 206 based on the universal serial bus (USB).

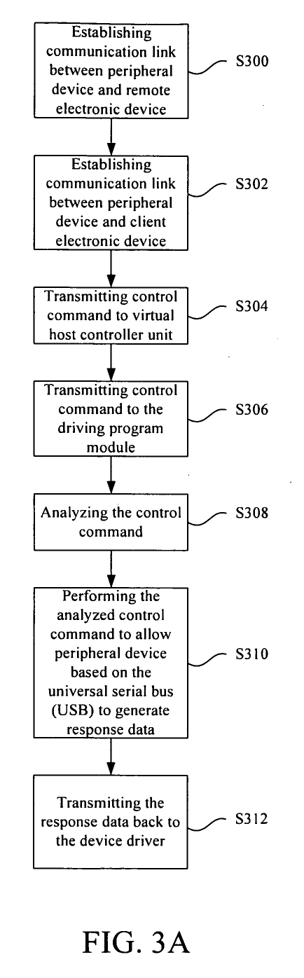

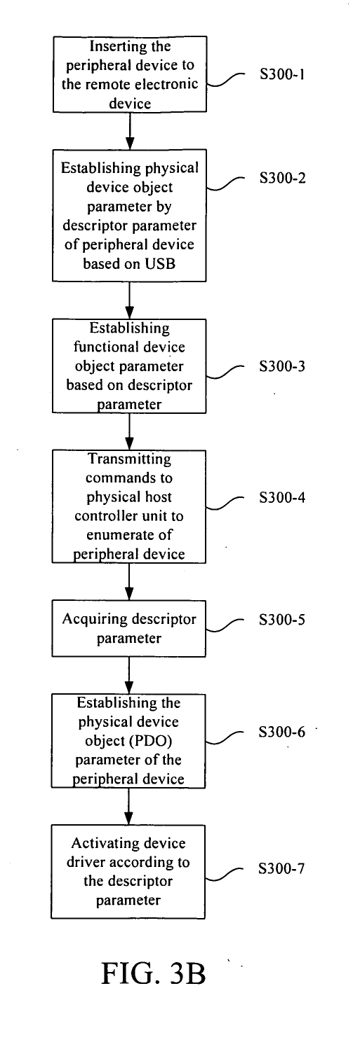

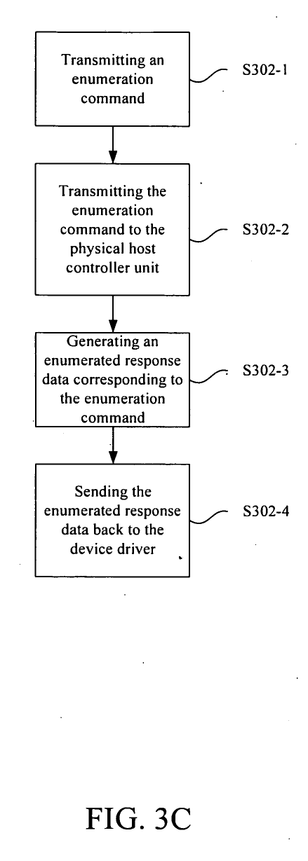

Please refer to FIG. 2 and FIGS. 3A-3C FIGS. 3A-3B are flow charts of performing the communicating method compatible to universal serial bus (USB) according to one embodiment of the present invention. The communication method is performed by the communication system 200. The communication system 200 includes a client electronic device 202 and a remote electronic device 204 coupled to a peripheral device 206 based on the universal serial bus (USB). The client electronic device 202 has a device driver 208, a virtual host controller unit 210, and a client application program module 212. The remote electronic device 204 has a remote application program module 214, a driving program module 216, and a physical host controller unit 218 coupled to the peripheral device 206 based on the universal serial bus (USB). The communication method includes the following steps:

As shown in FIG. 3A, in step S300, a communication link between the peripheral device 206 and the remote electronic device 204 based on the universal serial bus (USB) is established. In one embodiment, the remote electronic device 204 further enumerates the peripheral device 206 based on the universal serial bus (USB), as shown in FIG. 3B. The enumeration step in FIG. 3B further includes the following steps:

In step S300-1, the peripheral device 206 based on the universal serial bus (USB) is inserted to the remote electronic device 204.

In step S300-2, the physical host controller unit 218 further establishes a physical device object parameter by a descriptor parameter of the peripheral device 206 based on the universal serial bus (USB).

In step S300-3, the driving program module 216 establishes a functional device object parameter based on the descriptor parameter.

In step S300-4, the driving program module 216 transmits a plurality of commands to the physical host controller unit 218 to allow the remote electronic device 204 to enumerate the peripheral device 206.

In step S300-5, the remote application program module 214 acquires the descriptor parameter of the peripheral device 206 based on the universal serial bus (USB).

In step S300-6, the virtual host controller unit 210 establishes the physical device object (PDO) parameter of the peripheral device 206 based on the acquired descriptor parameter.

In step S300-7, the client electronic device 208 activates the device driver 208 according to the descriptor parameter.

In step S302, a communication link between the peripheral device 206 and the client electronic device 202 is established via the remote electronic device 204. In one embodiment, the client electronic device 202 further enumerates the peripheral device 206 based on the universal serial bus (USB), as shown in FIG. 3C. The enumeration step in FIG. 3C further includes the following steps:

In step S302-1, the device driver 208 transmits an enumeration command to the virtual host controller unit 210.

In step S302-2, the client application program module 212 receives the enumeration command from the virtual host controller unit 210 and transmits the enumeration command to the physical host controller unit 218 of the remote electronic device 204 via the remote application program module 214 and the driving program module 216.

In step S302-3, the peripheral device 206 generates an enumerated response data corresponding to the enumeration command based on the enumeration command from the physical host controller unit 218.

In step S302-4, the peripheral device sends the enumerated response data back to the device driver 208 of the client electronic device 202 via the remote electronic device 204.

Please refer to FIG. 3A continuously. In step S304, the device driver 208 of the client electronic device 202 transmits a control command to the virtual host controller unit 210. For example, the control command is a reading command, a writing command, and/or a device control command for controlling the peripheral device 206 based on the universal serial bus (USB).

In step S306, the remote application program module 212 receives the control command from the virtual host controller unit 210 and transmits the control command to the driving program module 216 of the remote electronic device 204.

In step S308, the remote application program module 214 analyzes the control command.

In step S310, the physical host controller unit 218 performs the analyzed control command to allow the peripheral device 206 based on the universal serial bus (USB) to generate response data corresponding to the analyzed control command.

In step S312, the peripheral device 206 transmits the response data back to the device driver of the client electronic device.

The communication system allows a client electronic device 202 to directly control and access the peripheral device 206 based on the universal serial bus (USB). The peripheral device 206 is connected to the remote electronic device 204 as if the peripheral device 206 based on the universal serial bus (USB) is directly connected to the client electronic device 202 as though the client electronic device 202 is capable of directly controlling and accessing the peripheral device 206.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A communication system compatible to universal serial bus (USB) and connected to a peripheral device based on the universal serial bus (USB), the communication system comprising:
a client electronic device, for establishing a communication link between the peripheral device and the communication system, the client electronic device comprising:
a device driver, for transmitting a control command;
a virtual host controller unit, for receiving the control command from the device driver and storing the control command; and
a client application program module, for receiving the control command from the virtual host controller unit and sending the control command; and
a remote electronic device, for establishing a communication link between the peripheral device and the remote electronic device, the remote electronic device comprising:
a remote application program module, for analyzing the control command from the client application program module;
a driving program module coupled to the remote application program module for controlling the peripheral device based on the universal serial bus (USB); and
a physical host controller unit coupling the driving program module to the peripheral device based on the universal serial bus (USB), for performing the analyzed control command;
wherein the peripheral device based on the universal serial bus (USB) generates response data corresponding to the analyzed control command and the peripheral device based on the universal serial bus (USB) transmits the response data back to the device driver of the client electronic device.

2. The communication system of claim 1, wherein the remote electronic device further enumerates the peripheral device based on the universal serial bus (USB).

3. The communication system of claim 2, wherein the physical host controller unit further establishes a physical device object (PDO) parameter of the peripheral device by a descriptor parameter of the peripheral device based on the universal serial bus (USB).

4. The communication system of claim 3, wherein the driving program module establishes a functional device object (FDO) parameter based on the descriptor parameter.

5. The communication system of claim 3, wherein the driving program module transmits a plurality of commands to the physical host controller unit to allow the remote electronic device further to enumerate the peripheral device based on the universal serial bus (USB).

6. The communication system of claim 3, wherein the driving program module comprises an application program interface to allow the remote application program module to control the peripheral device via the application program interface by using the analyzed control command.

7. The communication system of claim 3, wherein the remote application program module further acquires the descriptor parameter of the peripheral device based on the universal serial bus (USB).

8. The communication system of claim 7, wherein the virtual host controller unit further establishes the physical device object parameter of the peripheral device based on the acquired descriptor parameter, and the client electronic device further activates the device driver according to the descriptor parameter.

9. The communication system of claim 8, wherein the client electronic device further enumerates the peripheral device based on the universal serial bus (USB), and the device driver further transmits an enumeration command to the virtual host controller unit.

10. The communication system of claim 9, wherein the client application program module further receives the enumeration command from the virtual host controller unit, and transmits the enumeration command to the physical host controller unit of the remote electronic device via the remote application program module and the driving program module sequentially.

11. The communication system of claim 10, wherein the peripheral device based on the universal serial bus (USB) generates an enumerated response data corresponding to the enumeration command based on the enumeration command from the physical host controller unit and sends the enumerated response data back to the device driver of the client electronic device via the remote electronic device.

12. The communication system of claim 1, wherein the control command further comprises a reading command and a writing command.

13. A communicating method compatible to universal serial bus (USB) and applicable a communication system, wherein the communication system comprises a client electronic device and a remote electronic device coupled to a peripheral device based on the universal serial bus (USB), and wherein the client electronic device comprises a device driver, a virtual host controller unit, and a client application program module, and the remote electronic device comprises a remote application program module, a driving program module, and a physical host controller unit coupled to the peripheral device based on the universal serial bus (USB), the method comprising the steps of:
(a) establishing a communication link between the peripheral device and the remote electronic device based on the universal serial bus (USB);
(b) establishing a communication link between the peripheral device and the client electronic device via the remote electronic device;
(c) transmitting a control command to the virtual host controller unit by the device driver;
(d) receiving the control command from the virtual host controller unit by the client application program module, and transmitting the control command to the driving program module by the remote application program module;
(e) analyzing the control command by the remote application program module;
(f) performing the analyzed control command by the physical host controller unit to allow the peripheral device based on the universal serial bus (USB) to generate response data corresponding to the analyzed control command; and
(g) transmitting the response data back to the device driver of the client electronic device by the peripheral device.

14. The method of claim 13, during the step (a), further comprising the steps of:
(a1) inserting the peripheral device based on the universal serial bus (USB) to the remote electronic device; and
(a2) establishing a physical device object of the peripheral device by a descriptor parameter of the peripheral device based on the universal serial bus (USB) by the physical host controller unit.

15. The method of claim 13, after the step (a2), further comprising the steps of:
(a3) establishing a functional device object parameter based on the descriptor parameter by the driving program module; and
(a4) transmitting a plurality of commands to the physical host controller unit to allow the remote electronic device by the driving program module further to enumerate the peripheral device.

16. The method of claim 13, after the step (a4), further comprising a step of: (a5) acquiring the descriptor parameter of the peripheral device based on the universal serial bus (USB) by the remote application program module.

17. The method of claim 13, after the step (a5), further comprising a step of:
(a6) establishing the physical device object (PDO) parameter of the peripheral device based on the acquired descriptor parameter by the virtual host controller unit; and
(a7) activating the device driver according to the descriptor parameter by the client electronic device.

18. The method of claim 13, during the step (b), further comprising enumerating the peripheral device based on the universal serial bus (USB), wherein the step of enumerating the peripheral device further comprises the steps of:
(b1) transmitting an enumeration command to the virtual host controller unit by the device driver; and
(b2) receiving the enumeration command from the virtual host controller unit and transmitting the enumeration command to the physical host controller unit of the remote electronic device via the remote application program module and the driving program module by the client application program module.

19. The method of claim 13, after the step (b2), further comprising the steps of:
(b3) generating an enumerated response data corresponding to the enumeration command based on the enumeration command from the physical host controller unit by the peripheral device; and
(b4) sending the enumerated response data back to the device driver of the client electronic device via the remote electronic device by the peripheral device.

20. The method of claim 13, wherein the control command further comprises a reading command and a writing command.
